(19) United States
(12) Patent Application Publication
(10) Pub. No.: US 2005/0196532 A1
(43) Pub. Date: Sep. 8, 2005

(54) Hydrogel coatings and their employment in a quartz crytal microbalance ion sensor

(76) Inventors: Alex A. Waldrop III, South Portland, ME (US); David Alan Hoagland, Granby, MA (US); Douglas Warren Howie JR., Parkersburg, WV (US)

Correspondence Address: Law Office of William B. Ritchie, 43 Jackson Street, Concord, NH, 03301, US

(21) Appl. No.: 11/037,674

(22) Filed: Jan. 18, 2005

Related U.S. Application Data
(63) Continuation-in-part of application No. 10/635,289, filed on Aug. 6, 2003, now abandoned.
(60) Provisional application No. 60/401,660, filed on Aug. 6, 2002.

(51) Int. Cl. B05D 3/12

(52) U.S. Cl. 427/240

(57) ABSTRACT

A method to attach hydrophilic and/or ionogenic coatings to metallic surfaces robustly. Important applications for the invention extend to sensor types, various biomedical devices, and additional technologies requiring metal coatings with specified properties, such as sensors that employ the Quartz Crystal Microbalance (QCM) principle. This is a method to produce an adherent hydrogel against a metal surface by gelling a liquid mixture of components. The implementation of the invention for QCM ion sensors employs poly(allylamine) (PAH) hydrogels. The reaction of PAH with N-Acetylhomocysteine thiolactone (AHTL) (Fluka) in water under basic conditions produces thiol groups. This reaction removes ion exchange functionality and permits robust attachment of the hydrogel to the QCM's gold electrode. The PAH concentration in the aqueous starting mixture is between 12 and 25 weight percent, the AHTL concentration is between 5 and 25 mole percent of PAH repeat units, and the DadMac concentration is between 10 and 15 mole percent of PAH repeat units. Also, between 0.1 and 0.8 equivalents of base (sodium hydroxide, NaOH) are present per equivalent of PAH repeat units.

This application is continuation in part of U.S. application Ser. No. 10/635,289, filed on Aug. 6, 2003 which claimed benefit of priority under 35 U.S.C. §119(e) to U.S. Provisional Application Ser. No. 60/401,660 filed on Aug. 6, 2002.

### BACKGROUND OF INVENTION

1. Field of the Invention

The present invention generally relates to attaching hydrophilic and/or ionogenic coatings to metallic surfaces robustly. Important applications for the invention are sensors that employ the Quartz Crystal Microbalance (QCM) principle, but applications extend to other sensor types, various biomedical devices, and additional technologies requiring metal coatings with specified properties.

2. Description of the Related Art

The potential of QCM sensors for detecting substances present at low concentrations in liquids has sparked much activity in both the patent and research literatures. To achieve high sensitivity and high selectivity to a targeted substance, the QCM's active area (that in contact with the liquid) must normally be coated with a functional layer that complexes or adsorbs the substance. Sensitivity is defined in terms of the lowest concentration of a substance that can be detected, and selectivity is defined as the ability to distinguish one substance in the presence of similar substances. In a thickness shear mode QCM device, the active area is a metal electrode. Various QCM coatings have been discussed in the literature, including cross-linked films that have been molecularly imprinted, self-assembled monolayers that anchor chemical functionality, and physically adhered solid films that host similar functionality. Most often, the coating has been applied to enhance detection of specific organic or biological molecules. Films with ion exchange functionality have been described in a few instances, but not those that might facilitate detection of small ions by their complexation or adsorption. Also, uncoated QCMs able to detect contaminants that spontaneously adsorb to the electrode surface have been reported, as have uncoated QCMs able to detect ions in solution via field-ion interactions (acousto-electric effect). When sensitive and selective to a liquid contaminant, QCM sensors are competitive with other sensor types in terms of cost, speed of response, physical size, and other measures of practical performance.

Ion-exchanging hydrogels are particularly attractive as coatings for QCM sensors targeting small ions in solution. Ion exchange is the process by which ions are exchanged between a solution and an insoluble phase. In general, the insoluble phase, or ion exchange medium, contains fixed ionic sites of charge opposite to the exchangeable ions. Charges of the ionic sites are neutralized by the reversible binding of exchangeable ions of opposite charge; the exchangeable ions are thus referred to as counterions. The exchange of counterions between solution and insoluble phase occurs so that the net charge of the insoluble phase remains constant. The total charge of the ions that can be exchanged from solution equals to the total charge of all ionic sites of the ion exchange medium, defining the medium's ion exchange capacity. Different counterions have different affinities for the fixed ionic sites of the ion exchange medium, defining an affinity sequence. At equal concentration, a counterion species that is more strongly bound will displace from the ion exchange medium a counterion species that is less strongly bound. This exchange releases the less strongly bound species into solution.

An ion exchange medium with positive charged fixed sites can exchange anions (negative ions), so this type of medium is termed an anion exchange medium. An ion exchange medium with negative fixed sites can exchange cations (positive ions), so this type of medium is termed a cation exchange medium. Typical anion exchangers contain protonated or quaternary amine functionalities. Typical cation exchangers contain functionalities such as sulfonate, sulfate, phosphate, or carboxylate.

A QCM sensor coated with an ion-exchanging hydrogel will change mass as counterions are exchanged, if as usually is the case, these counterions vary in molar mass. This mass change causes a detectable change in the QCM resonant frequency. The mass change for an ideal QCM ion sensor roughly tracks the ion-exchange capacity of the coating on the QCM's surface. Thus, a coating with high capacity is needed to make an ion sensor with high sensitivity. The sensor's selectivity, on the other hand, will reflect the affinity sequence of the hydrogel. This sequence is a function of the hydrogel's chemistry as well as of solution conditions. The best QCM ion sensor possesses a coating that endows both high sensitivity and high affinity to the target ion.

Numerous obstacles to the practical use of QCM sensors, including highly undesirable delamination/debonding of the functional coating from the QCM's electrodes, usually made of gold, are known. Gold, like other metals from the coinage family, has hydrophobic surfaces, not liking aqueous environments or hydrophilic materials. Due to the fact that the interfacial energy for a hydrophilic coating in intimate contact with hydrophobic surface is large, spontaneous delamination/debonding is expected when a hydrophilic coating is physically deposited on an unmediated (bare) metal surface. Also, most hydrophilic materials swell in contact with water, producing interfacial mechanical stresses that enhance the likelihood of the debonding/delamination.

For further background in the operation of QCM ion sensors, see ”Quartz Crystal Microbalance (QCM)-Based Ion Sensors” by two of the present inventors (Hoagland and Howie), in Polymer Preprints 2001, 42(2), 619, which is the preprint for a talk of the same title presented to the Polymer Division of the American Chemical Society at their national meeting in Chicago, the entire preprint is incorporated herein by reference. One of the most important uses of the invention lies within the field of water quality determination, and more specifically, on-line sensors for that purpose. To date, coated QCM sensors have not been applied in this field except as described in U.S. Pat. No. 5,990,648. A broadly practical on-line sensor for harmful ions would have great commercial and societal impact, inasmuch as many of the most harmful contaminants of water are dissolved as ions. The U.S. Environmental Protection Agency establishes guidelines for the concentrations of these ions permitted in drinking water and allowed in industrial effluents. These levels generally range from parts-per-billion to parts-per-million. The list of regulated contaminants found in water as ions includes nitrate, nitrite, mercury, lead, arsenic, copper, chromium, cadmium, and many others. Currently, testing for these ions is done nearly exclusively by wet chemistry or chromatographic methods that are slow, expensive, error prone, and labor intensive. The few possible on-line methods (ion selective electrodes, conductivity) have problems associated with sensitivity, selectivity, interferences, and robustness. Because of these problems, the Environmental Protection Agency rarely permits testing of drinking water or industrial effluents by these methods, and even then, only for a handful of the least toxic ion types. In the absence of on-line sensors, most water quality determinations entail batch tests in off-site laboratories that may not return results for several days.

Ligand exchange hydrogels also can be used to detect small ions including many previously mentioned. In a ligand exchange hydrogel a metal containing moiety is attached to the hydrogel in a way that leaves available ligand-binding sites on the metal that can bind ligands contained in the fluid contacting the sensing layer. The metal containing moiety can include a chelating group which binds the desired metal such that one or more binding sites on the metal can undergo exchange. Typically this means that the chelating group does not occupy all the metal binding sites. The metal containing moiety can also include an organometallic compound where the metal has one or more carbon-metal covalent bonds. Ligand exchange hydrogels complement ion exchange hydrogels. The selectivity sequence of ligands for a given ligand exchange hydrogel will depend on the metal participating in the exchange and on the number of available exchange sites on the metal. This sequence will be different from the sequence of the standard types of anion exchangers. Moreover ligand exchange can involve binding of ligands that are not anions. A ligand has an electron pair that it can share with a metal; thus a ligand is a Lewis base. Additionally, metal ions differ in the rate that they exchange ligands so by changing the metal the rate of exchange can be altered affecting how rapidly one ligand replaces another. Arsenic contamination of drinking water is an example of the type of problem that a QCM ion sensor might address According to a Year 2000 World Health Organization press release, arsenic contamination of drinking water in Bangladesh is a ”catastrophe on a vast scale,” affecting between 35 and 77 million people of the country's total population of 125 million. At least 100,000 cases of debilitating skin lesions are believed to have already occurred. Similar arsenic contamination of ground water has been found in many other countries, including the United States. Technologies for removal of arsenic are available, but on-line methods for monitoring the efficacy of these technologies are absent and desperately needed. An ion exchange hydrogel used for detecting arsenic as arsenate ion has potential utility, but is subject to interference from other anions in the sample. With many of these ions likely to be present at significantly higher concentrations than arsenate in environmentally important samples such interference makes standard anion exchangers less than ideal for use in a hydrogel being used to measure the low concentrations of arsenate required by the new EPA arsenic standard of 10 ppb arsenic. The likely interfering anions present in groundwater include chloride, bicarbonate, carbonate, nitrate, sulfate, silicate, and phosphate. The standard anion exchange selectivity has sulfate binding stronger than phosphate and arsenate in near neutral pH. A hydrogel containing chelated iron (III) should not bind sulfate, chloride, nitrate, carbonate, or bicarbonate very strongly, since the binding constants for these ions binding to free iron (III) is low. Iron (III) does bind silicate, phosphate, and arsenate. A selectivity sequence in the literature for GFH indicates that arsenate has the highest binding constant of these three. Other transition metals with similar selectivity can also be chelated by a hydrogel with a chelating group attached and can be used instead of iron(III) and may have properties that make them preferable to iron(III). For example, the ligand exchange rate for iron (III) is slow; by using a metal ion with a faster exchange rate the binding of the ligands to the chelated metal will occur faster and regeneration will also be quicker and easier.

While the invention discloses several methods for endowing ion-exchange and ligand exchange functionality to QCM ion sensors, the same methods more generally can facilitate robust attachment of polymeric hydrogels to metal surfaces for other purposes. The methods produce a ”chemisorbed” as opposed to a ”physisorbed” hydrogel layer. A chemisorbed layer has specific chemical interactions with a surface that approach the strength of a chemical bond. A physisorbed layer, on the other hand, has only nonspecific, van der Waals-type interactions with such a surface, and the strengths of these weaker interactions are more comparable to those that cause a gas to condense into a liquid. A physisorbed layer readily desorbs/debonds from a surface while a chemisorbed layer usually does not. Thus, in many applications, a physisorbed layer is less desirable. In addition, as noted earlier, most hydrogels will not form a stable physisorbed layer on the hydrophobic surfaces of coinage metals. Important applications of the disclosed invention are envisaged in biomedical devices that contact hydrogels with metals, electrochemical sensors requiring permeable coatings, and electrochemical actuators exploiting the volume change of hydrogels to do mechanical work. This list is not comprehensive.

There is not found in the prior art a successful method for forming adherent hydrogels on metals or for using such hydrogels to detect ions as part of a QCM sensor. By using ion-exchanging or ligand exchanging hydrogels in a QCM sensor, ions such as nitrates, phosphates, arsenic as arsenates or arsenites, chromium, copper, and organic or heavy metal contaminants may be detected. The same sensing strategy applies to gels that ion exchange/capture cations or those that capture ions or ligands by binding mechanisms other than ion exchange, such as ligand exchange. Targets may include ligands, cations and anions, including species formed by complexation. Ligands may be neutral or charged.

### BRIEF DESCRIPTION OF THE DRAWINGS

FIG. 1 is the chemical reaction responsible for the thiolation of poly(allylamine) by treatment with N-acetyl homocysteine thiolactone.

FIG. 2 is the chemical reaction responsible for the alkylation and crosslinking of poly(allylamine) by diallyldimethylammonium chloride.

FIG. 3 is a graph showing representative frequency response of a thiolated poly(allylamine) QCM sensor made in accordance with the invention. In this experiment, the sensor is repetitively challenged in its chloride form by four-hour exposures to aqueous solutions containing 5 millimolar nitrate (mM) (indicated on the figure by the label “LINO3 5e-3”, reflecting nitrate present in the form of its dissolved lithium salt). With each challenge, the resonant frequency of the sensor drops by approximately 1500 Hz, corresponding to conversion of the sensor to its nitrate form. The drop is reversed in each case when the challenging nitrate solution is withdrawn, being replaced by a solution containing 5 mM chloride (indicated on the figure by the label “KCL 5e-3”, reflecting chloride present in the form of its dissolved potassium salt).

FIG. 4 is the chemical reaction responsible for the thiolation of poly(vinyl alcohol) by treatment with thiourea.

FIG. 5 is the chemical reaction responsible for the thiolation of poly(vinyl alcohol) by treatment with thioacetate.

FIG. 6 is the chemical reaction responsible for the proposed thiolation of poly(allylamine) by ethylene sulfide. Other cyclic sulfides may be used in place of ethylene sulfide.

FIG. 7 is the chemical reaction responsible for the alkylation of poly(allylamine) by organic halides. ”R” designates a linear or branched alkyl unit that may contain additional chemical functionality. The chemical structure of R can be manipulated to enhance ion specificity. The aklylation converts the primary amine to a secondary, tertiary, or quarternary amine depending on the number of R units attached to the nitrogen.

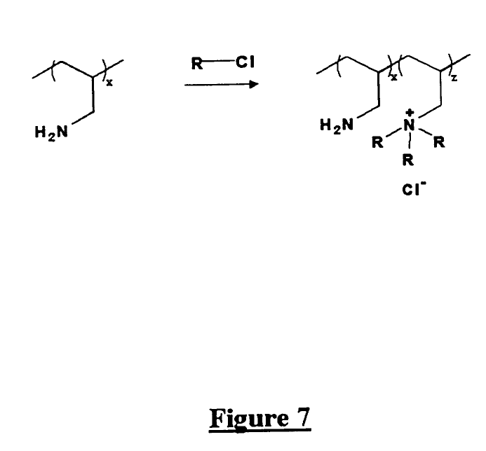

FIG. 8 is a representation of several chemical reactions that can be employed to protect the thiol group during liquid-state processing of thiol-containing polymers.

FIG. 9 is a representation of the adsorbed layers formed by two different mercapto acids.

### DETAILED DESCRIPTION OF THE INVENTION

The invention discloses general methods for forming water-swollen hydrogels strongly adherent to metals as well as the application of such hydrogels to make QCM sensors that monitor for the presence and concentration of small ions in liquids. The substances that may be detected by said sensors include simple anions such as chloride and bromide, oxyanions such nitrates, phosphates, and arsenates, and simple or complexed metals ions formed by elements such as chromium, lead, copper, cadmium, arsenic, mercury, and the like. Indeed, the sensors disclosed herein are likely suitable for all aqueous ions and aqueous ligands. Many different adherent hydrogels can be created by the methods described, and when incorporated into a QCM sensor, this flexibility plays an important role, allowing ion or ligand specificity to be tuned according to the chemical functionalities incorporated within the hydrogel. Chemical functionalities in the hydrogel may be chosen so that QCM sensors operate via ion exchange, ligand exchange, chelation, complexation or any combination thereof Applications extend beyond QCM sensors to include all situations where a hydrogel film is formed in contact with a metal surface and must adhere robustly.

In its broadest sense, the invention is a method for producing an adherent hydrogel against a metal surface by gelling a liquid mixture of components. Gelling creates a three-dimensional chemical or physical network that transforms the mixture into a solid. A chemical network interconnects base polymer or monomer through covalent bonds, while a physical network interconnects base polymer or monomer through strong noncovalent interactions such as hydrogen bonding or van der Waals interactions. In addition to the base polymer or monomer that will comprise the hydrogel network, the mixture may include constituents that promote or cause gelling and constituents that promote or cause chemisorption of the network to the metal surface. Chemisorption entails the formation of specific bonds to the surface. A key element of the invention is concurrent formation of these bonds as the hydrogel network itself forms. In this manner, the tendency of a hydrogel to delaminate from a metal surface to which it is attached can be sharply minimized if not altogether eliminated. In many applications, it is desired to include in the liquid mixture constituents that copolymerize or otherwise react to endow the hydrogel with functional properties such as ion exchange.

Preferred Embodiment: Thiol-functionalized Ion-exchanging Hydrogels: Strongly adherent, ion-exchanging or ligand exchanging hydrogels provide homogenous coatings enabling a new class of QCM ion or ligand sensors. Thus, a new class of QCM sensors is provided. A high density of fixed ionic or ligand exchange sites can be placed in a homogeneous hydrogel enhancing sensor sensitivity. In addition, the ionic sites or ligand exchange sites are readily accessed by counterions or ligands in a liquid contacting the coating, enhancing sensor response time. Further, the thickness of a homogenous hydrogel coating can be readily altered and controlled. Coating thickness is observed to affect QCM response strongly. Appropriately prepared homogenous hydrogels are chemically and mechanically stable in most aqueous environments to which ion sensors are exposed. Lastly, homogenous hydrogels mechanically couple well to the QCM electrode, a feature important to shear wave propagation, a key element of successful QCM operation.

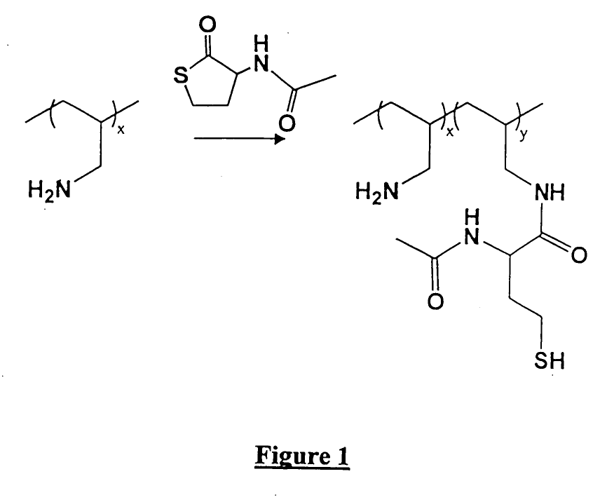

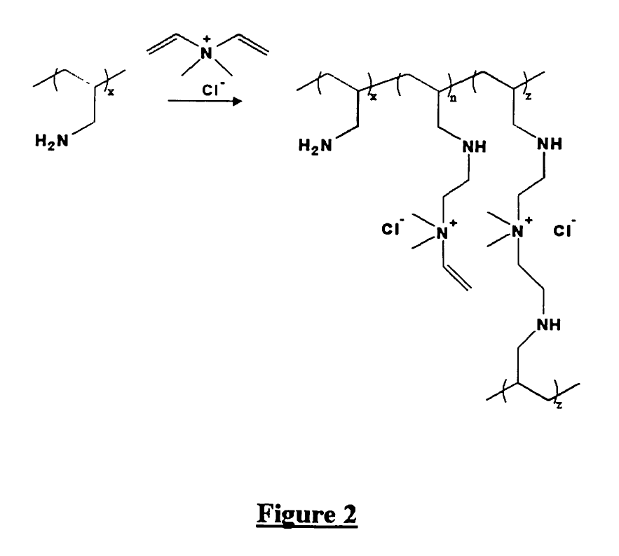

The preferred implementation of the invention for QCM ion sensors employs poly(allylamine) (PAH) hydrogels. Suitable PAH is available from commercial sources such as the Aldrich Chemical Company, and the implementation is not unduly sensitive to the properties (molecular weight, branching, etc.) or purity of this material. PAH contains nitrogen as primary amines that are protonated in water below pH 9; the pKa of PAH is 9.67 according to Environmental Science and Technology, Vol. 37, No. 2, 2003, pp. 423-427. These protonated amines are well known to act as ion-exchange sites, and thus PAH hydrogels are anion exchangers below pH 9. The reaction of PAH with N-acetylhomocysteine thiolactone (AHTL) (Fluka) in water under basic conditions produces thiol groups, as shown in FIG. 1. High levels of thiolation, defined as the percentage of the original PAH repeat units that are thiolated, are not particularly desired via the reaction of FIG. 1, since this reaction removes ion exchange functionality. Fortunately, even low levels of thiolation permit robust attachment of the hydrogel to the QCM's gold electrode. For the range of reaction conditions examined (corresponding to yields for the reaction shown in FIG. 1 of about 50%), thiolation levels remain between 2.5 and 12.5%. Viable sensors have been produced across this range. Crosslinks are concurrently formed by the alkylation of PAH with diallyldimethylammonium chloride (DadMac) (Aldrich) as shown in FIG. 2. As the layer forms on the metal QCM surface, thiolation, crosslinking, and attachment occur together, at rates that depend principally on the pH, the concentrations of constituents, and the temperature. In preferred implementations, the PAH concentration in the aqueous starting mixture is between 12 and 25 weight percent, the AHTL concentration is between 5 and 25 mole percent of PAH repeat units, and the DadMac concentration is between 10 and 15 mole percent of PAH repeat units. Also, between 0.1 and 0.8 equivalent of base (sodium hydroxide, NaOH), are present per equivalent of PAH repeat units. As noted below, the pH range is critical in order to achieve a viable commercial QCM. Other constituents in the aqueous mixture may be present but are not necessary.

In the preferred embodiment for anion exchange applications, the components described in the previous paragraph are mixed as follows: (1) the PAH is added to a solution of the NaOH and DadMac in water, (2) the AHTL is dissolved in a small volume of water, and (3) the solution of step 2 is rapidly added to the solution of step 1. The liquid mixture resulting from step 3 is immediately spun onto the QCM surface using a spin coater that rotates the QCM at 2000-3000 RPM. The delay between mixing and spinning should be less than 1 hr. The liquid-coated QCM is placed in an oven at temperature 120° C. for between 4 and 18 hrs, after which the QCM element is ready for use in a sensor. The best adhesion can be achieved by then removing that portion of the hydrogel coating that does not cover the QCM electrode by razor, but this step provides only a minor advantage. After rinsing with water or NaCl solution, no special precautions are needed to store a hydrogel-coated QCM in air for long periods. When submerged in water, coatings made by the preferred embodiment remain well adhered and viable in sensor applications for a period exceeding two months.

In an alternative embodiment, bisacrylamide is employed in place of DadMac to crosslink PAH. However, side reactions (yellowing) in the hydrogel coating are much less significant when DadMac is used. Indeed, any crosslinking reagent having multiple double bonds could potentially be effective in place of DadMac. A distinct advantage of DadMac over most crosslinking agents for anion exchange applications is that ion-exchange sites are not diluted or lost in crosslinking as, for example, occurs with amidation, a more common crosslinking chemistry for amine-containing polymers. The hydrolytic stability of the formed crosslinks is also considerably greater than with amidation. Epoxide-type crosslinking agents themselves suffer from hydrolytic instability that discourages their use. Finally, DadMac and other allylamines have the crucial practical advantage of high water-solubility. In the preferred emodiment, with all reagents being water-soluble, gels can be thiolated and crosslinked by spinning films directly from aqueous solution.

In the preferred embodiment for ligand exchange and cation exchange applications, the PAH synthesis above is the starting point, but with one important difference. The crosslinker should be chosen to be either neutral, without adding functionality, or should contain or be part of the functionality desired or can be later reacted to be part of the desired functionality. The crosslinker should also react with the amines such that they are no longer anion exchange sites or are the desired functionality or part of it or can be later converted to be part of the desired functionality. A suitable choice for a neutral crosslinker is any short dicarboxylic acid with both acid groups activated by forming active esters; the di-N-oxysuccinimide ester of suberic acid is commercially available and is a suitable choice. For ligand exchange hydrogels the preferred crosslinker is the dianhydride of EDTA.

### EXAMPLE

Preparation of a PAH QCM Ion Sensor:

1. Weigh approximately 0.214 g of AHTL. Dissolve the AHTL in approximately 1 mL of purified water.
2. Weigh approximately 0.248 of PAH.
3. Combine 0.2 mL of 5.35M NaOH, 0.0664 ml of DadMac, and 0.7336 mL of purified water.
4. Add solution obtained in Step 3 to the weighed PAR provided in step 2.
5. Dissolve PAH. Add 0.125 mL of solution obtained in Step 1.
6. Mix and incubate at room temperature for approximately 30 minutes.
7. A bare QCM (International Crystal Manufacturing; overall dimensions, 0.538 inch diameter by 0.1 mm thickness; electrode specifications, 0.2 inch diameter by 100 nm thick gold circles concentrically deposited over 10 nm thick chromium on each face of the QCM; separately deposited gold leads connect the electrode circles to QCM's peripheral edge; nominal resonant frequency for the uncoated QCM, 10 MHz) was sequentially washed and air-dried with 2% (w/v) Alconox, 2.7 M aqueous NaOH, and DI water.
8. Place approximately two drops of mixture on gold plate of QCM, spin and oven dry at 120C for 24 hours.

The inventors expect the following example to represent the optimum.
1. Weigh approximately 0.214 g AHTL. Add purified water to the 1 mL mark. Dissolve the weighed AHTL into the water.
2. Weigh approximately 0.248 g PAH.
3. Mix 0.07 mL 5.35M NaOH, 0.8636 mL purified water with weighed PAH obtained in Step 2. Dissolve the PAH.
4. Simultaneously add 0.0664 mL DadMac and 0.125 mL of solution in obtained in step 1.
5. Mix and Incubate at room temperature for ˜30 min (may need no incubation).
6. Place approximately 2 drops of mixture on gold plate of QCM, spin and oven dry at 120C for 24 h.
7. Rinse with purified water after dry to remove salts and re-dry in oven for a few hours
   Testing Protocol of the Example PAH QCM Sensor:

The coated QCM was sealed in a custom flow cell by pressing an 0-ring against the QCM's quartz periphery, and in this fashion, exposing only the coated site to the test stream; the sealing O-ring was well away from the coated electrode. Test solutions were driven at approximately 1 milliliter/minute through the flow cell's inlet and outlet ports, spanning an enclosed fluid volume of approximately 100 microliters. A solenoid valve manifold upstream of the flow cell permitted switching of inlet flow streams. When a coated QCM was first installed in the flow cell, a stream of 5 millimolar KCl in RO water was injected through the inlet port for 4 hrs. This stream put the PAH hydrogel into its fully protonated chloride form and allowed equilibrium swelling of the previously dry hydrogel coating. After 4 hrs, the QCM resonated at a stable frequency (approximately 9.998 MHz) somewhat below the resonant frequency of the bare QCM (approximately 10.00 MHz). Resonant frequencies were measured in the active mode using an inductor-compensated lever oscillator circuit. By this method, resonant frequency can be measured to an accuracy of better than ±10 Hz.

Testing Results of the Example PAH QCM Sensor:

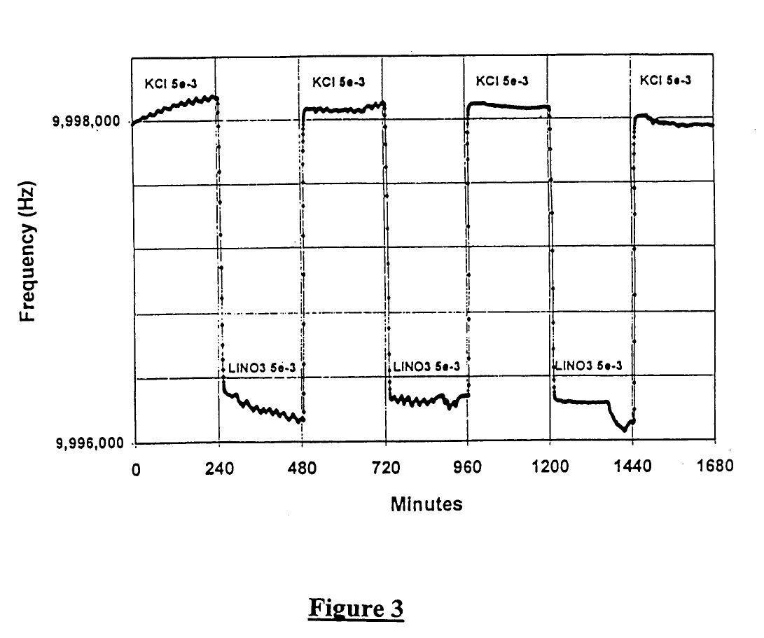

FIG. 3 is a graph showing the frequency response of the example PAH QCM sensor. To measure this response, the sensor was repetitively challenged in its chloride form by 4 hour exposures to flowing aqueous solutions containing 5 millimolar nitrate (indicated on the figure by the label ”LINO3 5e-3”, reflecting nitrate present in the form of its dissolved lithium salt; this molarity corresponds to 300 PPM nitrate). With each challenge, the resonant frequency of the sensor dropped by approximately 1500 Hz, corresponding to conversion of the sensor to its nitrate form. Nitrate is a more massive anion than chloride (molecular weight 62.0 g/mol vs. 35.5 g/mol), so the frequency shift arises from a mass change of the coated hydrogel Clearly, the nitrate ion exchanges for the chloride ion when the hydrogel is exposed to a nitrate solution; this exchange is expected from the affinity sequence for PAH. The frequency drop was reversed in each case when the challenging nitrate solution was withdrawn, being replaced by a solution containing 5 mM chloride (indicated on the figure by the label ”KCL 5e-3”, reflecting chloride present in the form of its dissolved potassium salt; this molarity corresponds to 172 PPM chloride). The hydrogel in its chloride form has a lower mass than the hydrogel in its nitrate form, so the QCM resonates at a higher frequency.

Effects other than mass change of the hydrogel layer may be responsible for some of the measured frequency shift, and the invention does not rely on the frequency shift being solely attributable to the mass change of ion-exchanging counterions. An additional mechanism that may contribute to the frequency shift is preferential swelling/deswelling of hydrogel. Observation of insensitivity of QCM response to co-ion mass (co-ions are identified as solution ions of the same charge as the fixed ionic functionality of the hydrogel) and frequency shifts of increasing magnitude for more massive counterions suggest, but do not prove, that mass change is the principle mechanism of action for sensor response. QCM ion sensors prepared in the same fashion as the example but exposed to nitrate concentrations as low as 6 ppm produced clear frequency shifts with good signal-to-noise.

Alternative Embodiments: A variety of similar hydrogels types and adhesion chemistries were examined, and many of these systems had valuable properties, although none performed as well in the application of QCM ion-sensing as the preferred embodiment of the invention. In other applications, these alternative embodiments may have superior properties. Additional embodiments have not been examined but directly follow from knowledge gathered in the course of the invention.

Alternative 1. Thiol-Functionalized, Ion-Capture Hyarogels. Ion capture, sometimes termed chelation, and ion exchange are often not explicitly acknowledged as separate phenomena in the ion-exchange literature. The inventors differentiate the two to distinguish gels acting predominately by electrostatic interactions from those acting predominantly by specific, non-electrostatic interactions. Many commercial chelating resins incorporate thiol groups to capture heavy metals. For example, it is expected that the preferred PAH embodiment may be altered to produce ion-capture films for heavy metals simply by thiolating all of the amine functionality by the chemistry described in FIG. 1. At high levels of thiolation, PAH crosslinks itself via disulfide bond formation, and thus an added crosslinking agent may not be needed. Processing films of this type is possible because the thiolation and crosslinking occur concomitantly after spinning films from solution.

Among the chelating hydrogel functionalities that might prove useful in QCM ion sensors are pyridyls, bipyridyls, terpyridyls, enamines, poryphins, phenanthrolines, cryptands, cyclic ethers, vicinal alcohols, thiols, thiosulfates, thiocyanates, sulfides, cyclic sulfides, and ethylenediamine tetraacetic acid (EDTA). Many of these functionalities have been described in the literature concerned with metal recovery and chromatography.

Alternative 2. Composite Coatings. In this embodiment, inert hydrogels and water-insoluble polymers are described as binders for encasing or otherwise attaching dispersed ion-exchanging media in composite coatings, enabling another class of QCM ion sensors. This class is distinguished by the coating's heterogeneous nature. In some instances, for example, chemical rigidity is needed in the vicinity of the ion exchange site to make the site more ion-selective. For high ion selectivity, therefore, composite coatings with dispersed ion exchange media may be preferred. The ready availability and diversity of commercial ion exchange resins enhances the attractiveness of composite coatings. Ion exchange media such as clay particles and zeolites may have desirable properties when used in this alternative form of the invention.

Hydrogels binders in the composite sensor approach combine the dimensional stability of a solid with the transport properties of a liquid, but a hydrophobic binder with a high loading of ion exchange material may also provide sufficient ion transport. In either case, ion permeability must be large enough to ensure that ions from a contacting solution can explore the coating in a reasonable time for sensing applications. Placement of thiols or sulfides in the binder may prevent debonding/delamination of the binder/ion-exchanger composite from the QCM surface. These and similar functionalities may also prevent debonding/cavitation of the binder from the ion exchange media.

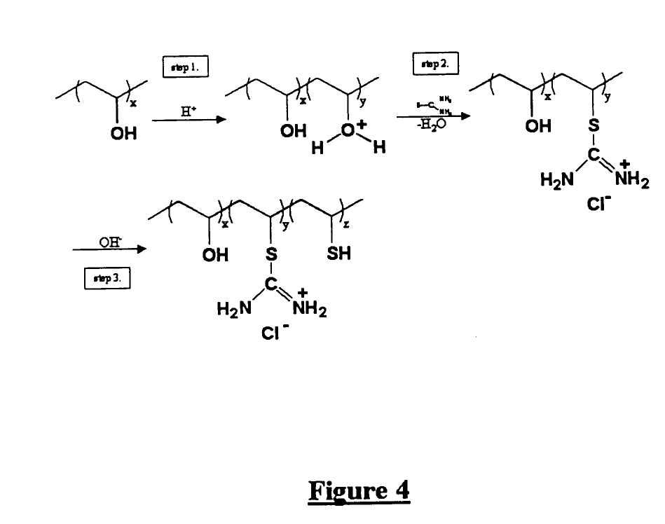

Thiolated poly (vinyl alcohol) was explored as an inert binder using the thiolation chemistry shown in FIG. 4. In this reaction chemistry, a precursor polymer possessing a small fraction of thiuronium groups is produced. The structure of the precursor polymer, in its thiuronium salt form, is shown as the product of the reaction's second step. After coating a gold surface with a mixture of precursor polymer and the desired ion exchange media, the thiuronium salt is hydrolyzed with base to form thiol groups, as illustrated by step 3. The thiols spontaneously react with the gold, adhering the ion-exchanging composite. Simultaneously, the base may gel the polyvinyl alcohol. Additional crosslinking, if needed, can be achieved by submerging the coated polyvinyl alcohol layer in an aqueous borate solution. The degree of thiolation needed for bonding the composite to the metal surface depends on many factors. However, adequate thiolation requires conversion of only a small percentage of the polymer's hydroxyl groups.

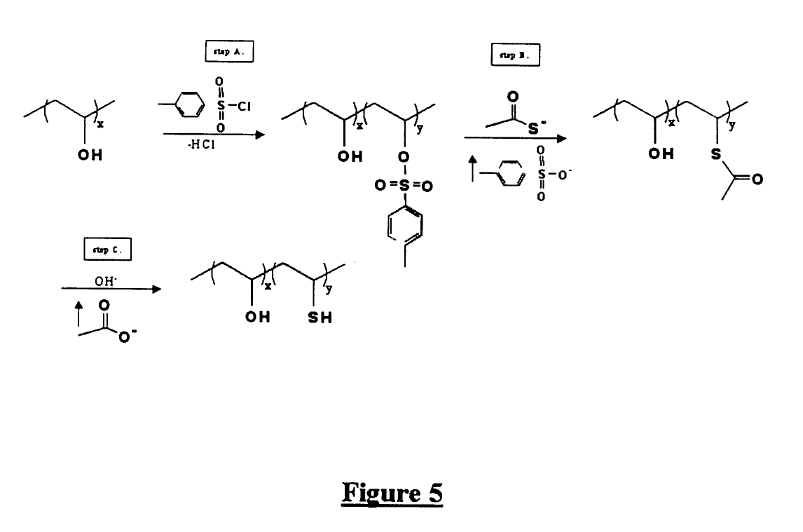

As shown in FIG. 5, treatment with tosyl chloride, thioacetate, and base provides an alternative route for thiolating hydroxyl-containing polymers such as polyvinyl alcohol. The thioester product of the reaction's second step can be admixed with ion exchange resin and spin coated on a gold surface. After coating, the thioester can be hydrolyzed with base to yield the thiol. Once again, crosslinking occurs as the thiols establish bonds with a metal surface.

Drawbacks to composite hydrogel coatings noted by the inventors are limited control over film thickness and difficulty preparing coatings thin enough to give optimized QCM response. The impact of hydrogel coating thickness on the sensitivity of a QCM ion sensor made by the disclosed invention remains poorly understood. Superficially, a thicker film might seem to have a higher capacity and thus offer greater sensitivity. The inventors have found, however, that films thinner than 1 micron (when dry) work much better than those that are thicker. This trend possibly can be explained in terms of the penetration depth (decay length) of shear waves into the hydrogel coating; QCM response relies on the propagation of shear waves from the electrode into the coating. In the literature, the penetration depth is generally assumed to be less than 1.0 micron for a fluid-like medium such as water. For a hydrogel penetration is greater to some unknown extent that depends on the hydrogel's complex mechanical properties. Portions of the hydrogel further from the electrode surface than the penetration depth do not positively contribute to QCM response. Indeed, our observation of poor response in thick films strongly suggests that these portions have a significant negative contribution, perhaps dampening the desired oscillations nearer to the electrode surface. Currently, ion-exchange particles (and other dispersed solid ion exchange media) smaller than approximately 10 microns are not readily available, and in their absence, liquid state processing to make coatings thinner than 10 microns is precluded.

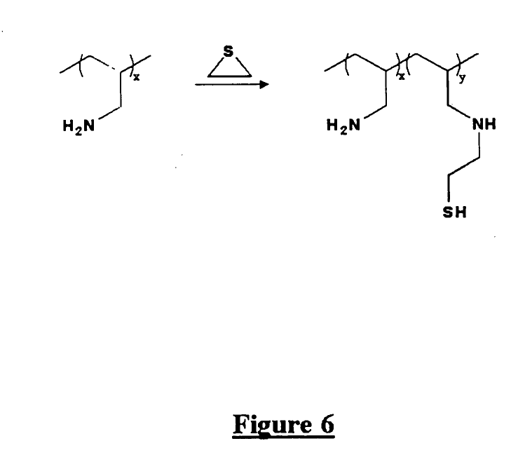

Alternative 3. Cyclic Sulfides for Thiolation of Amine-Containing Hydrogels. The reaction of PAH with cyclic sulfides to form thiols and sulfides outlines a possible path for making gold-adherent ion-exchanging gels. A schematic of this strategy is shown in FIG. 6. For simplicity, the concomitant formation of the oligo(ethylene sulfide) side chains is not shown. Other cyclic sulfides may be used in place of ethylene sulfide.

Alternative 4. Surface Prefunctionalization. In this alternative embodiment of the invention, adhesion of a hydrogel coating is attained by prefunctionalization of a metal surface with a monolayer of a thiol or sulfide compound that promotes hydrogel adhesion. The bridging of a hydrogel to metal by these sulfur-containing monolayers can be either covalent or physical. In the latter case, hydrogen-bonding, ionic bonding, chain entanglements, and similar noncovalent interactions between hydrogel and bridging compound promote adhesion of the hydrogel to the metal. The bonding of sulfur-containing compounds to coinage-family metals is well known, but methods exploiting monolayers of such compounds for the attachment of hydrogels to metal surfaces have not been reported.

To create poly(vinyl alcohol) hydrogel coatings on gold, three adhesion promoting compounds have been tested, 3-mercaptopropionic acid, 16-mercaptohexadecanoic acid, and 3-thiophene boronic acid. The structures of adsorbed molecules of the first two are shown in FIG. 10. Poly(vinyl alcohol) hydrogels can hydrogen bond to the acids of the adhesion-promoting compounds shown in FIG. 10, anchoring the hydrogels to the metal surface. The binding of thiophenes to gold is not shown in the same figure because, although the binding is known, the mechanism of this binding is not understood. The ability of boronic acid-substituted compounds to interact with poly(vinyl alcohol) is known. In cases where functionalization of the gelling material is difficult, the surface functionalization approach may be more appropriate.

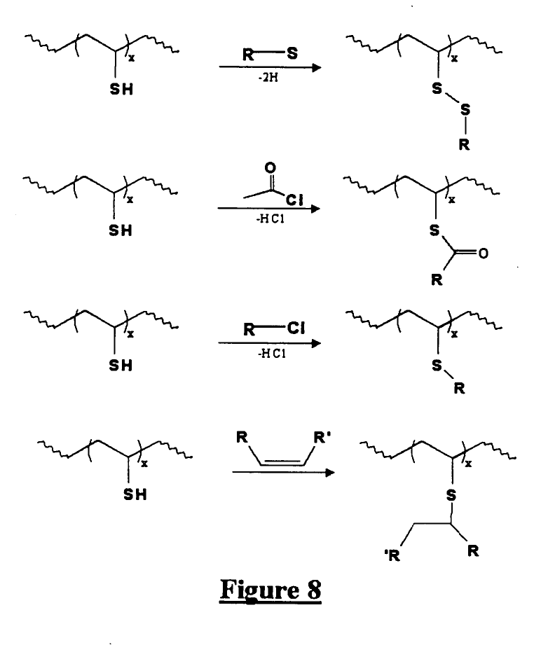

Alternative 5. Alkylated Hydrogels. Reaction of a thiolated hydrogel with alkyl halides, as shown in FIG. 8, can be performed to enhance ion specificity or expand the working pH range of a hydrogel-coated QCM sensor. The reaction product shown in the figure is a quaternary amine, but secondary and tertiary amines may also be produced by this sort of reaction. Ion specificity varies with the chemical identity and number of R group(s) incorporated by the alkylation reaction. Ion exchange is made essentially pH independent when the reaction product is a quaternary amine. Insensitivity to pH will be an extremely important coating property in QCM ion sensors used to detect ions in liquids of uncontrolled pH.

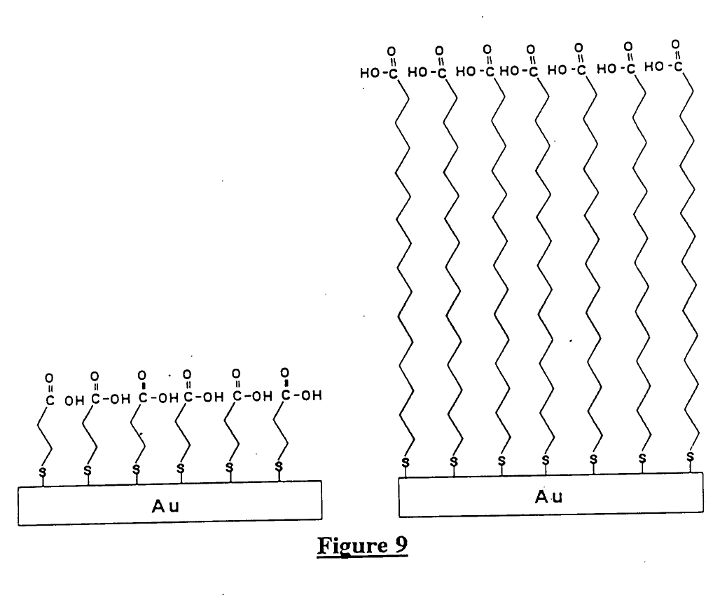

Alternative 6. Protection of the thiol group. Chemical protection of the thiol group may be necessary during processing to prevent crosslinking For example, the chemistry for thiolating hydroxyl-containing polymers shown in FIGS. 4 and 5 has the advantage that thiols are not formed directly, preventing premature gelation due to disulfide formation; premature gelation would disallow liquid-state coating processes. Several protection methods able to prevent premature disulfide crosslinking of thiol-containing polymers are shown in FIG. 9.

Advantages of the Disclosed Method over Prior Art

The disclosed invention differs markedly from any prior art but can be contrasted to two studies that report similar QCM coating methods:
Chance and Purdy. Chance and Purdy reported sensors based on commercial, crosslinked polystyrene ion-exchange particles directly adsorbed to a QCM. Their sensor target, an antibiotic, was very large, with a molecular weight more than 50 times larger than our target, small ions. It should also be noted that the coatings reported by Chance and Purdy were not formed on the QCM electrode, as disclosed herein, but rather were physically adhered to the electrode as solid particles. Details of the mechanism by which the antibiotic was detected in Chance and Purdy's study were not reported and probably much different than those described here. Chance and Purdy did not mention the ion exchange properties of their coatings, and these coatings were not hydrogels. The films of the present invention are nominally 140 times thinner than those reported by Chance and Purdy, and the chemistries described here are completely different.
Kanekiyo et al. Kanekiyo et al. synthesized molecularly imprinted hydrogel coatings for QCM sensors. In one instance, their hydrogel exploited a disulfide compound for both crosslinking and adhesion. Unlike the disclosed invention, to form the QCM coating, the hydrogel was preformed (i.e., gelled in bulk), dried, thinly sliced, and adhered to the QCM electrode under vacuum. The nature of the obtained adhesion was not clearly identified. Processing preformed materials of this type, much as with the ion exchange particles of Chance and Purdy, has numerous disadvantages compared to the disclosed invention. As noted before, hydrogel thicknesses are larger than desired, adhesion is not strong or well controlled, and processing is laborious and irreproducible. The sensing mechanism described by Kanekiyo et al., molecular imprinting, departs from those here described.

A prescribed amount of NaOH/base must be added to the reaction for spin coating the QCM electrode. It has been found that using less than or equal to 1.0 equivalent of base is required. While it was possible to occasionally obtain films that worked using greater amounts, the quality of the resulting films varied from day to day and week to week and month to month Even if the same stock solutions or freshly made solutions of PAH, NaOH, DadMac, and AHTL on successive days were used, the film quality varied significantly. Further, even when a film did attach to the gold, the longevity of the film was variable.

At the high pH conditions, it might be expected that the rates of the reactions of the nucleophilic PAH primary amine groups and either the AHTL thiolactone carbonyl group or with the DadMac allyl groups to be rapid. However, at this high pH, one might also expect attack of these same groups by the competing nucleophilic hydroxide anion. Under these high pH conditions, the rate of hydrolysis of AHTL is fast. This is the likely reason that the results were so variable under high pH conditions. There is competition between the desired modification of the PAH and hydrolysis of AHTL and possibly of DadMac.

When the reaction of AHTL with a primary amine is viewed as a function of pH, it has been discovered that the optimum pH ranges should range between 8 and 10.7 with the optimum in the region of 9.67. Similarly the optimum pH for reacting PAH with DadMac is less than 11. A pH between 8 and 10.7 corresponds to the use of approximately 0.1 to 0.4 equivalents of base. The critical factor, though, is the actual pH; it must be below 10.7 for the AHTL reaction to work well enough to get strong bonding to the gold. An optimum pH is expected to be approximately 9.7. A pH higher than 10.7 causes the hydrolysis of AHTL to be too rapid.

Due to the competing nature of the reactants, it might be thought that it would be necessary to perform the reactions in two steps. That is, react the PAH with DadMac at a higher pH to get a high rate of cross-linking and then to lower the pH and add AHTL to get sufficient attachment of homocysteine to PAH to get tight bonding to gold. However, the inventors have discovered that good films can be obtained by doing these reactions simultaneously at a pH if the pH range mentioned above is selected. Unless the pH is in this range, performance is too poor to be commercially useful as producing workable films on a consistent basis is impractical for manufacturing purposes.

The illustrated embodiments of the invention are intended to be illustrative only, recognizing that persons having ordinary skill in the art may construct different forms of the invention that fully fall within the scope of the subject matter disclosed herein.

1. A method for robustly coating a polymeric hydrogel onto a QCM, said method comprising the steps of:
diluting a commercially available solution of DadMac with purified water;
adding NaOH and PAH wherein an aqueous solution having a pH in the range of 8.0 to 10.7 is obtained to provide a PAH solution;
dissolving AHTL in water to provide an AHTL solution;
vigorously agitating the AHTL solution with the PAH solution to obtain a coating solution;
spincoating the coating solution on onto the QCM.

2. The method of claim 1 wherein the metal of the QCM receiving the coating is gold.

3. The method of claim 1 wherein NaOH is present in the range of 0 to 1 equivalents per equivalent of PAH repeat units.

4. The method of claim 1 wherein the pH of the PAH solution is approximately 9.7.

5. A QCM sensor employing a coating as provided by the method recited in claim 1.
